(19) United States
(12) Patent Application Publication
(10) Pub. No.: US 2006/0083114 A1
(43) Pub. Date: Apr. 20, 2006

(54) One-touch time tracking system

(76) Inventors: William R. Leadingham, Mountain View, CA (US); Ben Ayed, (US)

Correspondence Address: WILLIAM LEADINGHAM, 1639 NOTRE DAME, MTN. VIEW, CA, 94040, US

(21) Appl. No.: 10/968,739

(22) Filed: Oct. 19, 2004

(51) Int. Cl. G04F 10/00

(52) U.S. Cl. 368/109

(57) ABSTRACT

A one-touch portable handheld time keeping and recording device displays a list of tasks, the time elapsed and the status for each task on a handheld device with a touch-sensitive display. The user indicates the start or end of a task by touching the task or by clicking on it. If the task is active, the timer for that task is stopped and the task duration is stored. If the task is not active, the timer for that task is activated and any active timer is stopped. The task durations are updated in real-time or periodically. The time information from the one-touch portable handheld time keeping and recording device can be synchronized with a PC and pulled to a central repository where is can be maintained and billed.

### FIELD OF THE INVENTION

This invention relates to automated time control equipment in general, and in particular, to apparatus for recording elapsed time and other information on a portable device.

### BACKGROUND OF THE INVENTION

Most lawyers and other professionals who keep time records do so by generating hand-written paper records or computer-based recording systems. Various types of time recording systems are commercially available which reduce the effort involved in keeping such time records. However, known commercially available systems utilizing paper and computer-based records do not completely remove the drudgery involved in keeping time records. These systems usually are difficult to operate, and are not adaptable to mobile workforce environments where users do not have continuous access to a computer.

Several inventions have addressed the problem of portable time tracking. Time Keeping and Recording Device (U.S. Pat. No. 5,229,981), Digital Multi Event Timer (U.S. Pat. No. 5,229,981) and Timer Device (U.S. Pat. No. 4,163,360) disclose hardware solutions for time tracking, but fail to disclose a convenient way for recording time in a mobile work environment.

The present invention reduces the time and effort required by a professional in keeping time records in a mobile workforce environment.

### SUMMARY OF INVENTION

A one-touch portable handheld time keeping and recording device displays a list of tasks, the time elapsed, and the status for each task on a handheld device with a touch-sensitive display. The user indicates the start or end of a task by touching a task or clicking on it. If the task is active, the timer for that task is stopped and the task duration is stored. If the task is not active, the timer for that task is activated and any active timer is stopped. The task durations are updated in real-time or periodically.

The time information from the one-touch portable handheld time keeping and recording device can be synchronized with a PC and pulled to a central repository where it can be maintained and billed.

### BRIEF DESCRIPTION OF THE DRAWINGS

The present invention will be more clearly understood after reference to the following detailed specifications read in conjunction with the drawings wherein:

FIG. 1 is a schematic of a one-touch time tracking device;

FIG. 2 is a block diagram of a one-touch time tracking device;

FIG. 3 is a flowchart illustrating the steps involved in capturing timing events using a one-touch time tracking device;

Similar reference numerals are used in different figures to denote similar components.

### DETAILED DESCRIPTION OF THE PREFERRED EMBODIMENTS

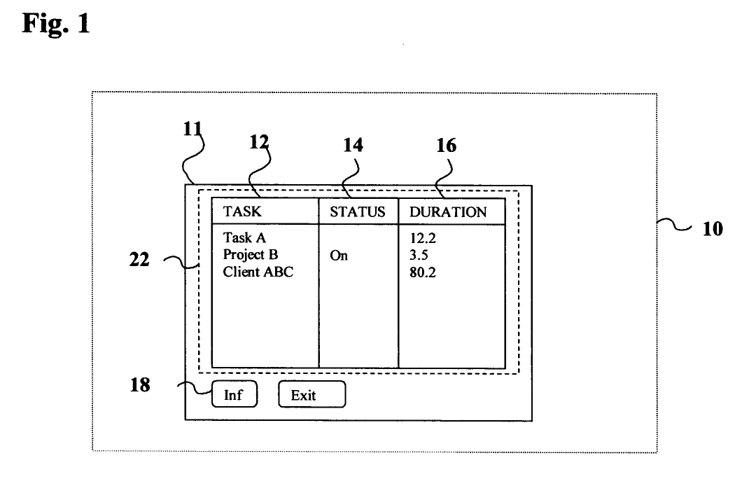

FIG. 1 is a schematic of a one-touch time tracking device 10 comprising a mobile computer system 11 with a touch sensitive display 22. A software runs on mobile computer system 11 and displays a task list 12 together with corresponding status 14, duration 16 and action buttons 18.

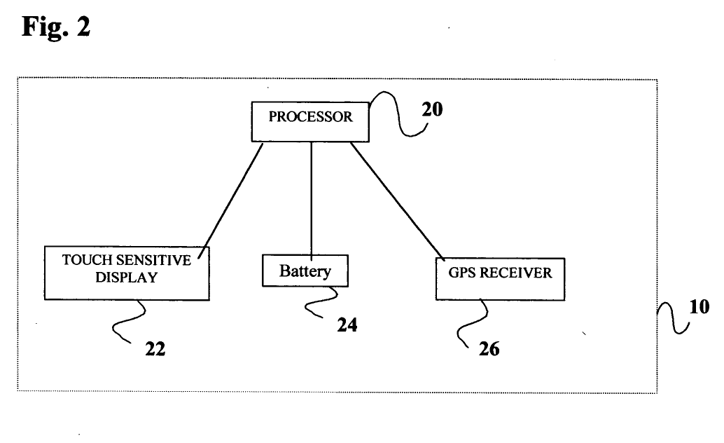

Referring now to FIG. 2, one-touch time tracking device 10 comprises a processor 20, a touch sensitive display 22, and a battery 24. In an alternative embodiment, a GPS receiver 26 may be added to device 10 in order to obtain location information.

When one-touch time tracking device 10 is not in operation it remains in dormant state (“sleep-mode”) to conserve the energy of battery 24. It will be understood that battery 24 may be nickel-cadmium, lithium, alkaline or nickel-hydride battery or any other portable source of electric power. Battery 24 can also be replaced with photovoltaic cells.

Touch sensitive display 22 can be any display system capable of sensing positional input or the user clicking a button drawn on the display.

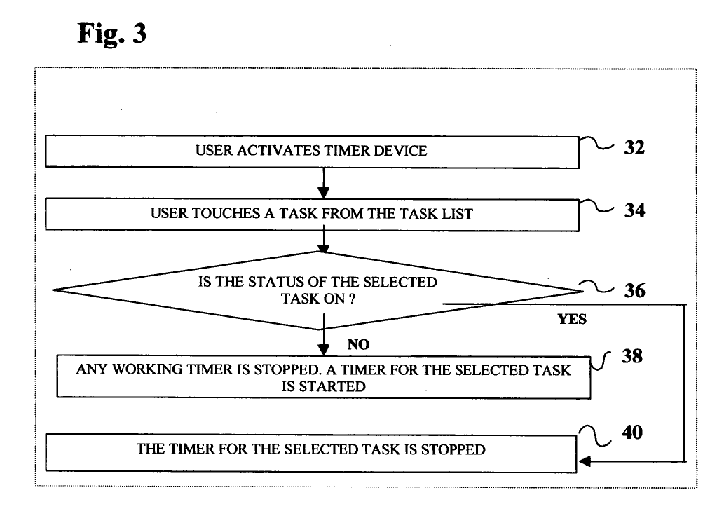

Turning now to FIG. 3, the flowchart illustrates the steps involved in capturing timing events using a one-touch time tracking device. In step 32, the user activates the one-touch time tracking device by pushing a switch or touching a sensitive display on handheld device 10. In step 34, the user touches a task from the task list. If the task is previously on, the timer for that task is turned off in step 40 and the task is updated. If the task is previously off, any working timer is stopped and a timer for the selected task is started in step 38. Processor 20 updates the duration information and stores it together with the time of the last update. This operation is performed either periodically, on activation of a button, or on activation of the one-touch time tracking device. If the system crashes or goes to sleep mode, the timing information is not lost. When a task is restarted, the new duration is added to the old recorded duration. Processor 20 may store durations as well as start and stop times.

Numerous other modifications, variations, and adaptations may be made to the particular embodiment of the invention described above without departing from the scope of the invention, which is defined in the claims.

What is claimed is:

1. A portable handheld time keeping and recording device, comprising:
a touch sensitive display for displaying a list of two or more tasks, the time elapsed and the status for each task,
wherein on touching an inactive task, said task starts and any active task is deactivated, and on touching an active task, said task is deactivated;
wherein on touching a task, the status for said task is updated;
a communication means for connecting to a synchronization console;
said touch sensitive display turns off if said device is idle for a period of time.

2. The apparatus of claim 1 comprising:
a GPS system for obtaining location information whereby on starting a task, said GPS system automatically obtains the current location information and stores it with the task information.

3. The apparatus of claim 1, wherein said communication means is a serial port.

4. The apparatus of claim 1, wherein said communication means is an infrared port.

5. The apparatus of claim 1, wherein said communication means is a Bluetooth transceiver.

6. The apparatus of claim 1, wherein said communication means is an 802.11 transceiver.

7. The apparatus of claim 1, whereby on activation of a switch, task information from said device is synchronized with task information contained in a computer system.

8. The apparatus of claim 7, comprising:
a user interface running on a said computer system whereby a user can maintain, activate and deactivate tasks using said user interface.

9. A method for recording time, comprising:
displaying a list of tasks with corresponding status and elapsed time on a portable handheld device;
on touching a task from the list of tasks displayed on a touch sensitive display:
if said task is active, said task is deactivated, its duration is computed and stored;
if said task is deactivated,
said task is activated, and its duration can be computed and stored;
any other started task is deactivated, its duration computed and stored.

10. The method of claim 9, whereby said tasks can be removed from said list of tasks.

11. The method of claim 9, whereby:
on activation of a synchronization button, said list of tasks is synchronized with a task database located pm a second computer system.

12. The method of claim 9, wherein:
on activation of a button, information from task databases from one or more computer systems are copied to a central database.

13. The method of claim 9, comprising:
sending an indication to the user if a task has been on for more than a maximum duration.

14. The method of claim 9 comprising storing start and stop times for said tasks.
